(19) United States
(12) Patent Application Publication
(10) Pub. No.: US 2004/0068468 A1
(43) Pub. Date: Apr. 8, 2004

(54) Method, system, computer program product and business method for budget allocation and account tracking

(76) Inventor: Cindy L. North, Las Vegas, NV (US)

Correspondence Address: WEISS & MOY PC, 4204 NORTH BROWN AVENUE, SCOTTSDALE, AZ, 85251, US

(21) Appl. No.: 10/266,858

(22) Filed: Oct. 7, 2002

(51) Int. Cl. G06F 17/60

(52) U.S. Cl. 705/39

(57) ABSTRACT

A method, system and computer program product for budget allocation and account tracking provide enhanced financial management software for households and small businesses. A business method provides service bureaus that use the method and optionally the software to provide personal service. A planning module and an account management module are initialized in an interview process, permitting prioritization of budgetary items that may be fixed or variable. A dual set of registers, one set for budgetary planning and one set for account tracking are initialized and each debit or credit is entered once into each set of registers. The debit/credit entry is entered in the account tracking registers in a register for the account associated with the debit/credit, while the debit/credit entry for the planning registers is entered a category associated with the entry. The software organization allows planning and reporting by category and allocation or reallocation of credits among fixed debits and planned expenses.

### BACKGROUND OF THE INVENTION

1. Field of the Invention

The present invention relates generally to financial management software and systems and more specifically, to a system integrating budget allocation with account tracking and a business method for providing budget management using service bureaus. 2. Background of the Invention

Software for financial management is commonly available for both home and business use. Typically, software packages for financial management are developed for operation on general-purpose personal computers, especially those intended for home use. Business financial management software is more likely to be network server-based or operated from a mainframe computer, but in general the operation of all financial management software is similar.

Software is available for accounting (record-keeping), and financial planning, and while software packages integrate the two functions, for example in business applications where inventory management, production forecasting and cost accounting are linked with accounts payable and receivable systems, or home accounting packages like QUICKEN and QUICKBOOKS (products of Intuit, Inc.), planning features are typically separated from accounting features or (do not exist) and thus do not provide sufficient linkage for effective financial planning. Software packages such as MICROSOFT MONEY (a product of Microsoft Corporation) include planning features, but are typically scenario-based and do not sufficiently integrate planning with actual expenditure management and accounting.

In some cases, persons requiring assistance with financial planning and budget management either desire or need to be personally assisted with the use of software or in setting up and maintaining a budget. Service bureaus exist for providing financial consultation, but as explained above, there is a need for better linking between financial planning with actual expenditure management and accounting.

Therefore, it would be desirable to provide a method and system, along with a computer program product for execution within the system, for providing closely linked financial planning and account management. It would further be desirable to provide a business method linking financial planning and account management through service bureaus.

### SUMMARY OF THE INVENTION

The above objective of providing closely-linked financial planning and account management is accomplished in a method, system, computer program product and business method that integrate budgetary allocation with account tracking. The method first assigns a set of credit/debit registers corresponding to real funds accounts, similar to checking and savings account registers. Second, the method assigns another set of credit/debit registers for planned expenditures and income corresponding to categories of the planned expenditures and income. When a credit/debit amount is entered the amount is registered in both one of the real funds account register (corresponding to where the credit is actually placed) and within one or more of the credit/debit registers for planned expenditures. Credits are allocated among one or more fixed or unfixed planned expenditures, according to priorities that are set up through an interview process or by other means. The business method comprises using the above features within a service bureau context to provide personal assistance to persons needing planning and accounting assistance.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a computer system in which the present invention is practiced,

FIG. 2 is a pictorial diagram depicting process flow within a system in accordance with an embodiment of the present invention.

FIG. 3 is a flowchart depicting a method in accordance with an embodiment of the present invention.

### DETAILED DESCRIPTION OF THE PREFERRED EMBODIMENTS

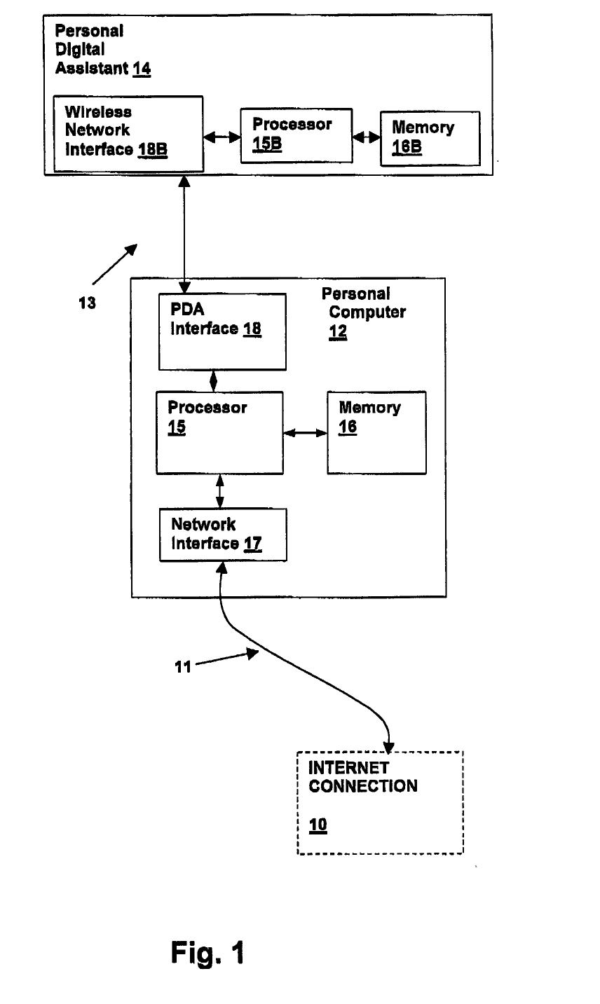

Referring now to the Figures, and with particular reference to FIG. 1, a computer system within which an embodiment of the present invention is practiced is depicted in a block diagram. A personal computer system 12 includes a processor 15 for executing program instructions coupled to a memory 16 containing program instructions embodying methods of the present invention (computer program products in accordance with embodiments of the present invention). Processor 15 is also coupled to a network interface 17 for connection via a modem line, DSL line or Ethernet connection 11 to an Internet connection 10 and a wireless or wired personal digital assistant (PDA) interface 18 for connection to PDA device 14. PDA 14 includes a processor 15B coupled to a memory 16B and an interface 18B for connection to personal computer system 12 via a wired (e.g., Universal Serial Bus—USB) or wireless interconnect 13 (e.g., infrared), cellular network, or other network.

The above-described computer system is exemplary only and should not be construed as limiting the scope of the present invention. The present invention concerns a software application for financial planning and management for execution within a general-purpose computer system such as personal computer 12 or a portable appliance such as PDA 14 or by a network browser executing within personal computer 12 and displaying view information pushed by a server from Internet connection 10. PDA 14 and Internet connection 10 are also shown connected to personal computer 12 to illustrate various features of the present invention, including remote shopping using data input features of PDA 14 and Internet shopping via website access provided by Internet connection 10.

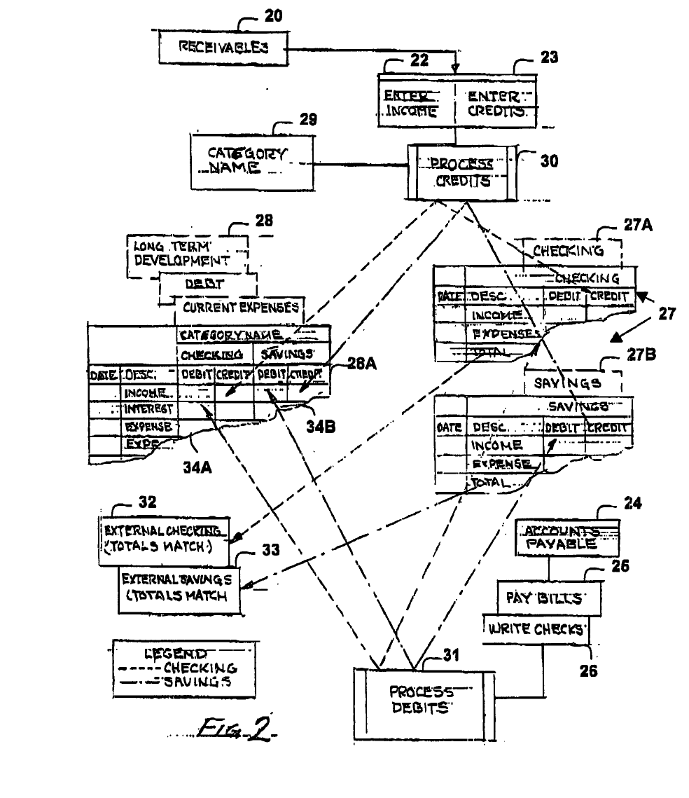

Referring now to FIG. 2, process flow within a method and system of the present invention are depicted. Credit and debit inputs to the illustrated method flow from two sources: receivables 20 and accounts payable 24. Receivables 20 generally comprise income 22 and other credit sources 23 and are processed in two places when received. Receivables 20 are entered into a register (similar in screen display and function to paper checking or savings account registers) representing real accounts such as checking register 27A, savings register 27B and for any other liquid funds (for example, money market accounts, cash investment accounts, etc.). Non-liquid funds may be linked within the relational database that manages accounts 27, but are entered as cash within one of accounts 27, since the funds must first be converted to liquid funds before use.

Receivables are then conformed with a set of planning registers that include category registers 28A for expenses, debts, long-term financial planning, etc. Input of a category name 29 is used to select the proper category register 28A from planning registers 28. Categories 28 include current expenses (for example, household expenses), long-term development (such as home downpayment savings, large purchase desires, retirement, etc.) and debt (such as student loan payments and other debts). The above-listed categories are exemplary and categories 28 may include other types of money-management categories.

Accounts payable 24 generally comprise debits such as bills 25, checks 26 along with other debits such as electronic funds transactions (EFTs). Both credits 30 and debits 31 are processed to conform with planning registers 28 with the real account registers 27 so that totals match for the external savings 33 and checking 32 accounts, as well as for any other liquid funds account. Debits may also proceed from a download of information contained in PDA 14 to personal computer 12, and may originate from use of PDA 14 as an actual payment device or from a record-keeping application executed by processor 15B within PDA 14. Debits may also originate from Internet connection 10 via on-line shopping activities and transfer of information to the financial management software of the present invention may be performed automatically, or a form may be generated by the financial management software for recording an Internet transaction.

Debits 24 are posted via the processing of block 31 to appropriate debit columns within both real account registers 27 and category registers 28. Credits 20 are posted to appropriate credit columns within both real account registers 27 and category registers 28. Separate sets of credit/debit columns 34A and 34B are maintained for each real account (in the exemplary illustration one checking and one savings account, but multiple accounts of any type are supported by the application software) so that when checking 32 and savings 33 totals are checked, they may be conformed against the appropriate column entry (34A or 34B) within category registers 28. The software application thus provides a completely up-to-date balance of both planned (category) and actual balances that are completely reconciled with on-going account activity. The software application provides a mechanism for providing reports that show a user's progress toward meeting the financial goals set up in the interview process and to reconcile long-term financial goals with short-term or ongoing needs. Use of the software's ability to shift and reallocate income among categories provides a way for the user to visualize the tradeoffs and prioritization available to them within their household or small business budget.

Software applications in accordance with various embodiments of the present invention include auxiliary accounting functions such as funds transfer, budget and planning report generation, check and statement printing, deposit slip printing, on-line banking, stock quotations and administrative functions. Administrative functions include security functions that enable an administrator or creator of a budget to setup and permit other users to access only portions of the registers within the software or only a portion of the functionality of the program. For example, parents may permit children to use the software to manage their own money or to enter desired expenditures within the planning categories without giving them full access to the family budget.

In one embodiment of the present invention, an on-line shopping session is initiated from the application software, for example by clicking a particular on-line shopping icon or selection from a user-configurable list of shopping sites, and a record-keeping entry form is generated in a window while the on-line shopping session is initiated. The user is reminded to record the amount and type of any purchasing activity in the record-keeping window, and the debit is automatically processed 31 when the window is closed or another action (such as an “OK” button press) is completed. Shipment tracking numbers may also be entered within the record-keeping window so the application software may remind the user periodically of shipments until they are received, providing a shipment tracking function in coordination with financial management functions. Shopping may also proceed from a particular category register, providing category shopping icons for shopping to within the associated category.

The interview process starts with default prioritization and category items that include fixed income sources, fixed expenditures such as house payments or rent, etc. The interview process may ask questions to determine some of the items using checkboxes or yes/no query/response. Various scenarios may be pre-installed, permitting the user to choose a particular type of financial management strategy, such as debt reduction, retirement planning, home purchase, unemployment or other scenario to meet a particular user's immediate or long-term needs. Default settings for particular types of users may be use to pre-configure the interview process for students, retirees, younger adults, children, etc.

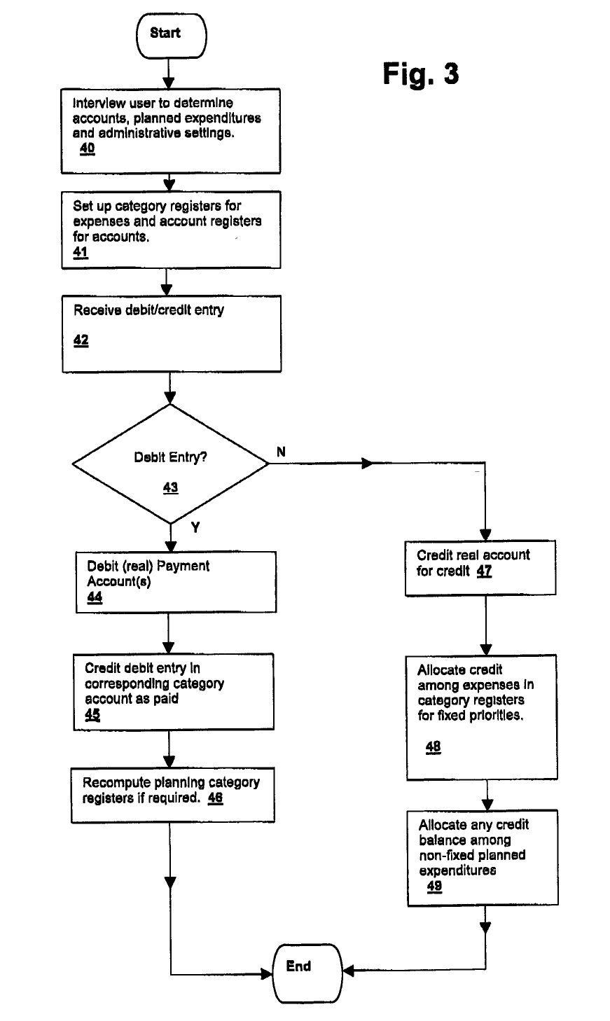

Referring now to FIG. 3, a method in accordance with an embodiment of the present invention is illustrated in a flowchart. The first time a user is registered with the application software (or at subsequent times when initiated by the user or it is determined that an update is required), an interview process is initiated to determine real accounts, categories, expenses within categories, income sources, and prioritization of payments for items within categories, along with administrative settings such as access for other users (step 40). A set of category registers and real account registers is set up from the interview information (step 41). When a debit or credit is entered (received) (step 42) if the entry is a debit entry (decision 43) the register for the real payment account or accounts associated with the debit is debited (step 44). Also, the debit entry is credited against an entry in the corresponding category register (step 45) (or a new entry is generated). The planning category register entries are recomputed if required (step 46), for example if payment of a debit causes a reallocation of future income that the category register debit entry was tying up. If the received credit/debit amount is for a credit (decision 43), the real account for the credit is credited (step 47) and the credit is allocated among expenses is the category registers for fixed priority payments (step 48). If a balance remains, the remaining credit is allocated among non-fixed planned expenditures (stop 49). Steps 42-49 are repeated for each debit and credit received by the software, while steps 40-41 are generally required only at setup, when changes are made to categories and priorities and when new real accounts are established.

The present invention provides a flexible financial planning system in which the planned expenditures are easily maintained and reconciled against on-going activities. The entry of every expenditure or credit into both a category register and a real account register provides accurate category expense reporting that has not been available in a financial planning application. Further, the reconciliation of account balance and readjustment of the category entries in response to actual credits and debits enables the present invention to provide a useful tool for users trying to accomplish particular financial goals.

A business method in accordance with an embodiment of the invention includes interviewing and financial management in accordance with the methods described above. Service bureaus provide interviewing and consultation services with or without the application software being available to the client, and generally using the software described above, but may use manual means in accordance with the above-described methods. For example, the client may not use software at all, but the service bureau agent uses the software to interview, produce reports for, and consult with a client. Or, the interview process may be conducted manually with direct entry in the category and account registers. Finally, the above-described methods may be applied to an ordinary computer-based spreadsheet or manual spreadsheet.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for financial management, comprising:
first assigning a first set of credit/debit registers corresponding to real funds accounts;
second assigning a second set of credit/debit registers for planned expenditures and income corresponding to categories of said planned expenditures and income;
receiving an credit/debit amount from an input source;
first registering said credit/debit amount within said one of said first set of credit/debit registers; and
second registering said credit/debit amount within said one or more of said second set of credit/debit registers.

2. The method of claim 1, wherein said receiving receives a credit amount, and wherein said second registering allocates said credit amount to one or more debits within said second set of credit/debit registers in response to said receiving.

3. The method of claim 2, wherein said second registering allocates said credit amount to said one or more debits in conformity with a predetermined prioritization of said one or more debits.

4. The method of claim 3, wherein said second set of registers includes fixed and unfixed debit entries, and wherein said second registering comprises:
allocating said credit about to said fixed entries;
computing an excess of said credit about above a total of said fixed entries;
determining whether or not said excess is greater than zero; and
in response to determining that said excess is greater than zero, allocating said excess among said unfixed debit entries.

5. The method of claim 1, wherein said receiving receives a debit amount, and wherein said second registering reallocates funds within said second set of credit/debit registers to conform to an adjusted balance that includes said received debit amount in response to said receiving.

6. The method of claim 1, wherein said debit amount is an on-line purchase amount, and wherein said method further comprises:
initiating an on-line shopping session on a network browser;
generating an entry form associated with said on-line shopping session for receiving information corresponding to said on-line shopping session, and wherein said receiving receives a user input from said entry form corresponding to said debit amount.

7. The method of claim 1, wherein said receiving further receives purchase shipment tracking information from said entry form, and wherein said method further comprises reminding said user of said shipment at a time subsequent to said purchase.

8. The method of claim 1, wherein said debit amount is a remote purchase amount, and wherein said method further comprises registering said remote purchase amount with a personal digital assistant, and wherein said receiving comprises downloading information corresponding to said remote purchase, said information including said remote purchase amount.

9. The method of claim 1, further comprising:
first interviewing a user to determine real account information;
in response to a result of said first interviewing, initiating said first set of credit/debit registers;
second interviewing a user to determine planned expenditures; and
in response to a result of said second interviewing, initiating said second set of credit/debit registers.

10. The method of claim 9, wherein said second interviewing receives a set of priorities from said user and assigns said priorities within said second set of credit/debit registers.

11. A computer system comprising:
a processor for executing server program instructions; and
a memory coupled to said processor for storing said server program instructions, wherein said server program instructions comprise program instructions for:
first assigning a first set of credit/debit registers corresponding to real funds accounts,
second assigning a second set of credit/debit registers for planned expenditures and income corresponding to categories of said planned expenditures and income,
receiving an credit/debit amount from an input source,
first registering said credit/debit amount within said one of said first set of credit/debit registers, and second registering said credit/debit amount within said one or more of said second set of credit/debit registers.

12. The computer system of claim 11, wherein said program instructions for receiving receive a credit amount, and wherein said program instructions for second registering allocate said credit amount to one or more debits within said second set of credit/debit registers in response to said receiving.

13. The computer system of claim 12, wherein said program instructions for second registering allocate said credit amount to said one or more debits in conformity with a predetermined prioritization of said one or more debits.

14. The computer system of claim 13, wherein said second set of registers includes fixed and unfixed debit entries, and wherein said program instructions for second registering comprise program instructions for:
allocating said credit about to said fixed entries;
computing an excess of said credit about above a total of said fixed entries;
determining whether or not said excess is greater than zero; and
in response to determining that said excess is greater than zero, allocating said excess among said unfixed debit entries.

15. The computer system of claim 11, wherein said program instructions for receiving receive a debit amount, and wherein said program instructions for second registering reallocate funds within said second set of credit/debit registers to conform to an adjusted balance that includes said received debit amount in response to said receiving.

16. The computer system of claim 11, wherein said debit amount is an on-line purchase amount, and wherein said program instructions further comprise program instructions for:
initiating an on-line shopping session on a network browser executing within the computer system; and
generating an entry form associated with said on-line shopping session for receiving information corresponding to said on-line shopping session, and wherein said program instructions for receiving receive a user input from said entry form corresponding to said debit amount.

17. The computer system of claim 11, wherein said program instructions for receiving further receive purchase shipment tracking information from said entry form, and wherein said program instructions further comprise program instructions for reminding said user of said shipment at a time subsequent to said purchase.

18. The computer system of claim 11, wherein said debit amount is a remote purchase amount, and wherein said program instructions for receiving further comprise program instructions for downloading information corresponding to said remote purchase from a personal digital assistant, said information including said remote purchase amount.

19. The computer system of claim 11, wherein said program instructions further comprise program instructions for:
first interviewing a user to determine real account information;
in response to a result of said first interviewing, initiating said first set of credit/debit registers;
second interviewing a user to determine planned expenditures; and
in response to a result of said second interviewing, initiating said second set of credit/debit registers.

20. The computer system of claim 19, wherein said program instructions for second interviewing receive a set of priorities from said user and assign said priorities within said second set of credit/debit registers.

21. A computer program product comprising signal-bearing media encoding program instructions for execution within a general-purpose computer system, wherein said program instructions comprise program instructions for:
first assigning a first set of credit/debit registers corresponding to real funds accounts,
second assigning a second set of credit/debit registers for planned expenditures and income corresponding to categories of said planned expenditures and income,
receiving an credit/debit amount from an input source,
first registering said credit/debit amount within said one of said first set of credit/debit registers, and second registering said credit/debit amount within said one or more of said second set of credit/debit registers.

22. The computer program product of claim 21, wherein said program instructions for receiving receive a credit amount, and wherein said program instructions for second registering allocate said credit amount to one or more debits within said second set of credit/debit registers in response to said receiving.

23. The computer program product of claim 22, wherein said program instructions for second registering allocate said credit amount to said one or more debits in conformity with a predetermined prioritization of said one or more debits.

24. The computer program product of claim 23, wherein said second set of registers includes fixed and unfixed debit entries, and wherein said program instructions for second registering comprise program instructions for:
allocating said credit about to said fixed entries;
computing an excess of said credit about above a total of said fixed entries;
determining whether or not said excess is greater than zero; and
in response to determining that said excess is greater than zero, allocating said excess among said unfixed debit entries.

25. The computer system of claim 21, wherein said program instructions for receiving receive a debit amount, and wherein said program instructions for second registering reallocate funds within said second set of credit/debit registers to conform to an adjusted balance that includes said received debit amount in response to said receiving.

26. The computer program product of claim 21, wherein said debit amount is an on-line purchase amount, and wherein said program instructions further comprise program instructions for:
initiating an on-line shopping session on a network browser executing within the computer system; and
generating an entry form associated with said on-line shopping session for receiving information corresponding to said on-line shopping session, and wherein said program instructions for receiving receive a user input from said entry form corresponding to said debit amount.

27. The computer program product of claim 21, wherein said program instructions for receiving further receive purchase shipment tracking information from said entry form, and wherein said program instructions further comprise program instructions for reminding said user of said shipment at a time subsequent to said purchase.

28. The computer program product of claim 21, wherein said debit amount is a remote purchase amount, and wherein said program instructions for receiving further comprise program instructions for downloading information corresponding to said remote purchase from a personal digital assistant, said information including said remote purchase amount.

29. The computer program product of claim 21, wherein said program instructions further comprise program instructions for:
first interviewing a user to determine real account information;
in response to a result of said first interviewing, initiating said first set of credit/debit registers;
second interviewing a user to determine planned expenditures; and
in response to a result of said second interviewing, initiating said second set of credit/debit registers.

30. The computer program product of claim 29, wherein said program instructions for second interviewing receive a set of priorities from said user and assign said priorities within said second set of credit/debit registers.

31. A method of doing business from a service bureau that provides financial management services, comprising:
receiving credit and debit information from a client;
first assigning a first set of credit/debit registers corresponding to real funds accounts;
second assigning a second set of credit/debit registers for planned expenditures and income corresponding to categories of said planned expenditures and income;
first registering said credit and debit information within said first set of credit/debit registers; and
second registering said credit and debit information within said second set of credit/debit registers.

32. The business method of claim 31, wherein said first and second assigning and said first and second registering are performed by a computer system, wherein said receiving is performed by a human agent of said service bureau, and wherein the business method further comprises entering said credit and debit information in said computer system.

33. The business method of claim 31, further comprising:
first interviewing a client to determine real account information;
in response to a result of said first interviewing, initiating said first set of credit/debit registers;
second interviewing a user to determine planned expenditures; and
in response to a result of said second interviewing, initiating said second set of credit/debit registers.

34. The business method of claim 33, wherein said second interviewing receives a set of priorities from said user and assigns said priorities within said second set of credit/debit registers.

35. The business method of claim 33, wherein said method is performed in conjunction with a computer system that receives input of information from said first and second interviewing and performs said first and second initiating in response to said receiving input of information from said first and second interviewing.
